(19) United States
(12) Patent Application Publication
(10) Pub. No.: US 2007/0150396 A1
(43) Pub. Date: Jun. 28, 2007

(54) Stock value chains

(75) Inventors: Oren Rossen, Caesarea (IL); Nir Ben Levy, Beer Yacov (IL)

Correspondence Address: Active Knowledge Ltd., POB 294, Kiryat Tivon, 36010, IL

(73) Assignee: GridStock Inc., Ramat Gan (IL)

(21) Appl. No.: 11/644,866

(22) Filed: Dec. 26, 2006

Related U.S. Application Data
(60) Provisional application No. 60/753,396, filed on Dec. 27, 2005.

(51) Int. Cl. G06Q 40/00

(52) U.S. Cl. 705/36 R; 705/35

(57) ABSTRACT

Methods for creating and maintaining stock value chains. One embodiment comprises the steps of receiving a stock symbol, creating a value chain for the stock symbol, and returning the value chain of the stock symbol.

### BACKGROUND

The embodiments of the present invention relate to value chains and, more particularly, to creation and use of stock value chains.

Complete theoretical descriptions, details, explanations, examples, and applications of code analysis and related subjects are readily available in standard references in the fields of computer science, economics, and stock investment.

### BRIEF SUMMARY

Herein, the term “stock symbol” may also refer to company name, group of companies, stock name, group of stocks, stock identification number, company identification number, index name, group of indices, index identification number, commodity name, group of commodities, commodity identification number, security name, group of securities, security identification number, industry, or any other information that can be used for identifying a specific stock or a specific group of stocks, or a security or a specific group of securities, or an index or a specific group of indices, or an option or a specific group of options, or a commodity or a specific group of commodities, or an industry.

Herein, the term “indicator” is defined as the buy or sell decision result of a mathematical or statistical function that rates the attractiveness of an investment.

Herein, the term “stock” may also refer to option, future, forward, commodity, currency, bond, bill, rate, index, fund, debt, future earning, reputation, mortgage, Exchange Traded Funds (ETF), loan, financial service, or any other publicly traded asset or security or index which may feature a price quotes, or non publicly traded financial service offering which may feature a price quotes.

Without limiting the scope of the present invention, herein, the term “stock identifier” is defined as any financial service identifier, and/or financial service keyword, and/or stock symbol, and/or company identifier, and/or a combination thereof.

Implementation of the methods for stock value chains of the embodiments of the present invention involves performing or completing selected tasks or steps manually, semi-automatically, fully automatically, and/or a combination thereof. Moreover, depending upon actual instrumentation and/or equipment used for implementing an embodiment of the disclosed methods, several embodiments could be achieved by hardware, by software, by firmware, or a combination thereof. In particular, with hardware, embodiments of the invention could exist by variations in the physical structure. Additionally, or alternatively, with software, selected functions of the invention could be performed by a data processor, such as a computing platform, executing a software instructions or protocols using any suitable computer operating system.

### BRIEF DESCRIPTION OF THE DRAWINGS

The embodiments of the present invention are herein described, by way of example only, with reference to the accompanying drawings. With specific reference now to the drawings, it is stressed that the particulars shown are by way of example and for purposes of illustrative discussion of the embodiments of the present invention only, and are presented in order to provide what is believed to be the most useful and readily understood description of the principles and conceptual aspects of the embodiments of the present invention. In this regard, no attempt is made to show structural details of the embodiments in more detail than is necessary for a fundamental understanding of the invention. The description taken with the drawings makes apparent to those skilled in the art how the several embodiments may be embodied in practice. Identical structures, elements or parts which appear in more than one figure are preferably labeled with a same or similar number in all the figures in which they appear. In the drawings:

FIG. 1 illustrates a high performance computer, in accordance with one embodiment of the present invention;

FIG. 2 is a schematic illustration of an investor sentiment barometer, in accordance with one embodiment of the present invention;

FIG. 3 is a schematic illustration of a value chain, in accordance with one embodiment of the present invention;

FIG. 4 is a schematic illustration of a value chain having four categories, in accordance with one embodiment of the present invention;

FIGS. 5-7 illustrate embodiments of investment strategies stock engines in accordance with the embodiments of the present invention;

FIGS. 8-11 illustrate methods for creating value chains in accordance with the embodiments of the present invention;

FIGS. 12-15 illustrates value chain embodiments in accordance with the present invention; and

FIGS. 16-17 illustrate two investor sentiment barometer embodiments in accordance with the present invention.

### DETAILED DESCRIPTION

The embodiments of the present invention are stock value chains. The embodiments are discussed in detail below. It is to be understood that the embodiments are not limited by the details of the order or sequence of steps of operation or implementation of the methods set forth in the following description, drawings or examples. While specific steps, configurations and arrangements are discussed, it is to be understood that this is done for illustrative purposes only. A person skilled in the relevant art will recognize that other steps, embodiments, configurations and arrangements can be used without departing from the spirit and scope of the present invention.

The embodiments of the present invention are capable of other embodiments or of being practiced or carried out in various ways. Moreover, it is to be understood that the phraseology, terminology and notation employed herein are for the purpose of description and should not be regarded as limiting.

Search Engine for Stock Investment Strategies:

The following disclosure includes three main sets of embodiments. The first set of embodiments discloses a search engine for stock investment strategies. The second set of embodiments discloses methods for creating, maintaining and using value chains. The third set of embodiments discloses a method of utilizing the inventors' sentiment.

It is to be understood that the present invention is not limited in its application by the details of the order or sequence of steps of operation or implementation of the method and/or the details of construction, arrangement, and composition of the components of the system set forth in the following description, drawings or examples. While specific steps, configurations and arrangements are discussed, it is to be understood that this is done for illustrative purposes only. A person skilled in the relevant art will recognize that other steps, embodiments, configurations and arrangements can be used without departing from the spirit and scope of the present invention.

The present invention is capable of other embodiments or of being practiced or carried out in various ways. Moreover, it is to be understood that the phraseology, terminology and notation employed herein are for the purpose of description and should not be regarded as limiting.

In the following description of the method of the present invention, included are only main or principal steps needed for sufficiently understanding proper ‘enabling’ utilization and implementation of the disclosed financial search engine and/or stock investment strategy search engine. Accordingly, descriptions of the various required or optional minor, intermediate, and/or sub steps, which are readily known by one of ordinary skill in the art, and/or which are available in the prior art and technical literature relating to stock investment, are not included herein.

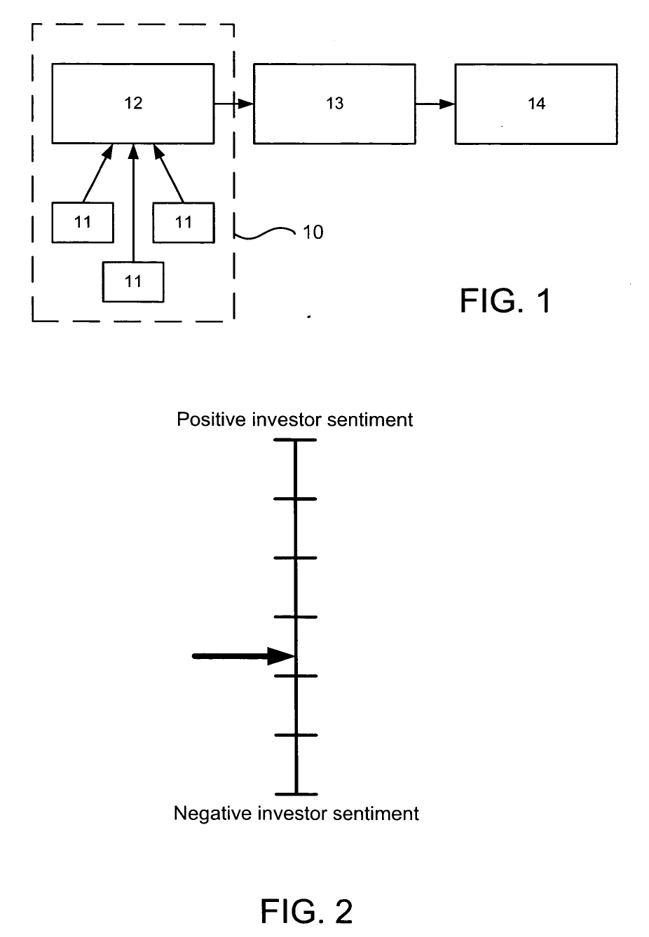

Referring to FIG. 1, in one embodiment, the system features the following elements: high performance computer 10, application server 13, and end-user applications 14.

The high performance computer 10 may feature a distributed computing network. Distributed computing networks are known in the art and almost any type of distributed computing network may be operated with the architecture of the invention. For example, a distributed computing network may feature grid server 12 with a plurality of calculating clients 11. Grid server 12 manages the distribution of the data, and calculating clients 11 run the computations.

The application server 13 receives the computation results from the high performance computer 10, sorts the results, and creates or updates the database that is used by the end-user applications 14.

The end-user applications 14 may also be known as the front-end of the system. In one embodiment, the end-user application 14 is the software application used by the end-user.

In one embodiment, end user application 14 may feature one or more of the following functions:
Displaying the calculated results per stock or per financial service.
Displaying the financial information of the selected stock or financial service.
Chatting and other means of communication between the users of the system.
Filtering and searching the results. For example, displaying only BUY stocks or stocks having values greater than X or financial service offers with a predefined payoff.
Alerting by Email.
Displaying a portfolio of stocks and/or a portfolio of financial services.
Displaying a chart of historical data of a selected stock or stocks, or rates or return or risk or payoffs or any other financial service.
Displaying a chart of historical data of a selected function or functions, or a combination of functions, or one or more investment strategies.
Displaying a chart of historical data of a selected stock showing the dates the investment strategy signal was Buy or Sell, or when the financial service offer was a Buy or a Sell.
Displaying a memo where a user can maintain personal notes or share notes with others.
Displaying a search box where the user can enter any parameter in search for any stock or group of stocks, or one or more investment strategies or financial service or financial service offer.
Displaying news and other written content about the stock or financial service or financial service offer.
Displaying statistics about the stock and/or the investment strategy and/or financial service and/or financial service offer.

In one embodiment of the invention, finding the best strategy algorithm involves performing a parallel statistical calculation whose objective is to find the best times for buying and selling a stock or other financial instrument or financial service. This statistical calculation may not converge into the optimal integration of strategies, but on the other hand, the statistical calculation may calculate all combinations, optionally with no correlation between the buying strategy and the selling strategy. Alternatively phrasing, the high performance computer calculates all the options and does not try to perform converging calculations. As a result, the embodiment calculates all strategy combinations, and it does not overlook combinations, as would be required in a strategy optimization algorithm.

One embodiment of the search engine for stock investment and financial service offering strategies is based on providing a user with a predefined number of the most relevant and/or best performing strategies for a selected stock and/or financial asset and/or debt and/or service offering.

The search engine may be operated by entering a name of a selected stock, or its symbol, or a financial service keyword, and receiving the strategies featuring the best performances, whether for investment or for consumption of a financial service. Alternatively, a user may enter a keyword and then be presented with stock symbols and/or company names of stocks and/or financial services that match the entered keyword. A user may then choose any stock or financial service and receive the investment strategies or financial service offering or strategies featuring the best performance.

In a similar manner to web search engines which provide the user with the most relevant web pages, one embodiment of the Stock Strategy Search Engine provides the user with a predefined number of the most relevant and/or best performing investment strategies or financial service offerings or strategies for a selected stock identifier or financial service.

Increasing the number of possible investment strategies and/or possible functions and/or possible sets of rules and/or possible financial service offerings, may increase the value of the search engine to its users because the search engine finds the best performances from the available information and/or range of strategies in the data-base.

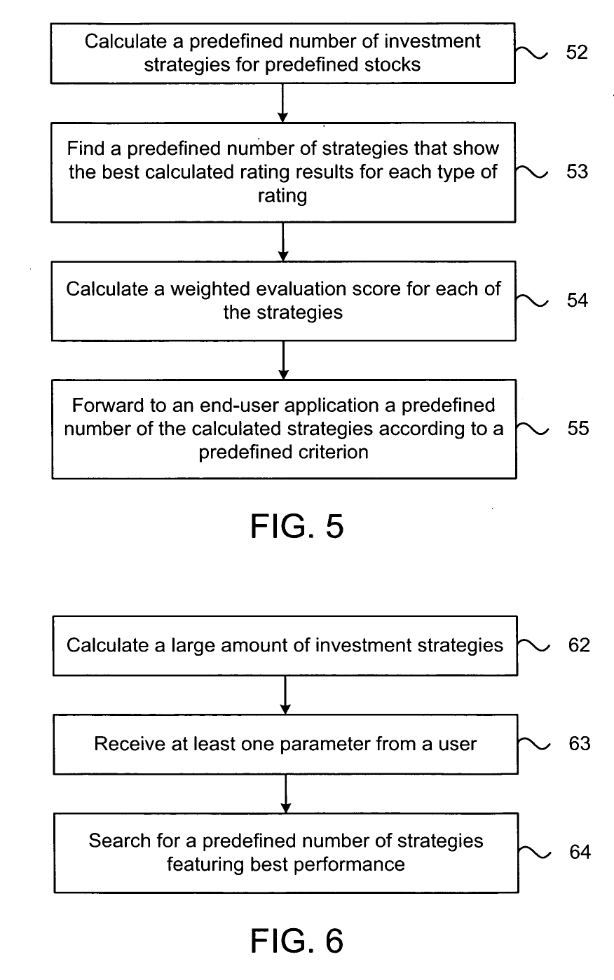

With reference to FIG. 5, one embodiment includes the following steps.

Step 52 in FIG. 5 illustrates the step of calculating a predefined number of investment strategies for predefined stocks. The term “investment strategies” as used herein also includes all types of financial strategies.

In the case of a distributed computing network as disclosed below, each calculating client calculates a predefined number of strategies or a range of strategies and returns to the grid server a predefined number of strategies that obtained the best-calculated rates or performance and/or that were found to apply to a predefined set of rules.

Examples of rating types, which may be used with the embodiments, are return on investment, ratios, Investor sentiment barometer, econometrics, volatility, risk, correlation, association, payoff and any other predefined rule.

In the case of a distributed computing network, each calculating client may calculate a predefined number of strategies and return to the grid server a predefined number of strategies that show the results with the best-calculated rates. Optionally, each calculating client may calculate and return to the grid server a predefined number of strategies that show the results with the best calculated ratings, which also performed to additional pre-defined rule or rules such as minimum number of trades, smallest payments, etc.

Step 53 in FIG. 5 illustrates the step of finding a predefined number of strategies that show the best calculated ratings results for each type of rating. After some of the calculating clients return their calculations, the grid server may sort the results for each type of rating and find a predefined number of strategies that show the best calculated ratings results for each type of rating. At this step, the grid server has accumulated many results showing the best-calculated ratings for each rating type.

Step 54 in FIG. 5 illustrates the step of calculating a weighted evaluation score for each of the strategies. The system calculates the weighted evaluation score, based on predefined combinations of rating types. This calculation may be performed either by the grid server or by the calculating clients. The weighted evaluation score may be, for example, the average or multiplication between a strategy return and the stock's volatility, or between a strategy success ratio and a stock's market capitalization.

Step 55 in FIG. 5 illustrates the step of forwarding to an end-user application a predefined number of the calculated strategies according to a predefined criterion. Optionally, a predefined number of the best-calculated strategies are then forwarded to an end user application. For example, in a case where the rating types of success ratio and return on investment are calculated, the end user application may display the strategy featuring the best success ratio, the strategy featuring the best return on investment, and a predefined number of strategies featuring the best-weighted evaluation score combining both types of rating.

Optionally, the method further includes the step of sorting the calculated strategies based on their weighted evaluation score before forwarding the predefined number of calculated strategies to the end-user application.

In one embodiment of the invention, the end-user application displays a list of mixed-strategy options that were checked for the predefined stocks or financial services. The user may choose an investment or financial service according to desired levels of risk and/or opportunity and/or payoffs.

In one embodiment of the invention, the content to be searched features stock investment strategies and/or financial strategies. Optionally, the strategies feature a combination of technical functions and/or financial functions. As known in the relevant art, technical functions are mathematical functions that result in one of two trading modes: Buy or Sell. Trading modes can be absolute, or each of the modes can be in a predefined range, implying for its strength or certainty. As known in the art, financial functions are mathematical calculations of payoff and/or risk.

With reference to FIG. 6, one embodiment includes the following steps.

Step 62 in FIG. 6 illustrates the step of calculating a large amount of investment strategies. The large amount of investment strategies calculated by the system may be based on a predefined number of functions, and a predefined number of combinations of the functions.

Step 63 in FIG. 6 illustrates the step of receiving at least one parameter from a user, in whole or in part. The parameter may be a stock symbol, a stock name, a return, a success ratio, a keyword, an index or any other identifier given by the user of the system. The user may be a computer, a software application, or a human being. Alternatively, the system may receive no parameter at all from the user, and direct the user to a list of results based on pre-defined rules. The list of results may be complete, or may be screened based on pre-defined rules. The list of results may be the same for all users, or may be different by applying pre-defined rules to different users based on predefined parameters such as, but not limited to, their location, their IP address, their computer or software characteristics, their past behavior on the system, their listed portfolio companies or symbols, other unique identifications such as cookies, or any other pre-defined rule.

Step 64 in FIG. 6 illustrates the step of searching for a predefined number of strategies featuring best performance. In contrast to prior art stock investment tools, which must receive from a user a stock symbol and at least one indicator to be checked in order to choose the best investment strategy or the best combination that produces the investment strategy, this embodiment may display the best strategy after receiving only one parameter relating to a stock (e.g. stock symbol, stock name, stock identification number, or keyword), in whole or in part, or not receiving any parameter at all from the user. This is because the system stores a large amount of pre-calculated investment strategies for each stock. After receiving a parameter in whole or in part, pointing to a specific stock, a predefined amount of best performing investment strategies is returned to the user. In cases where the parameter, in whole or in part, may point to more than one stock, a list of stocks is presented to the user, all of which fit the parameter that the user has entered into the system. In cases where the user does not enter any parameter or is not required to enter any parameter, a list of at least one stock is presented to the user based on pre-defined rules as elaborated above.

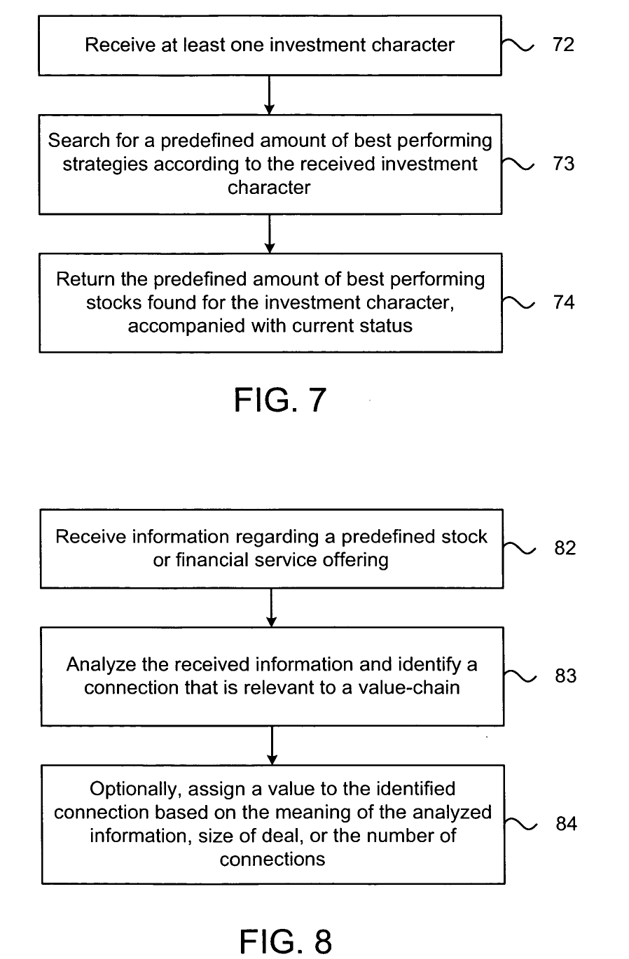

With reference to FIG. 7, one embodiment includes the following steps.

Step 72 in FIG. 7 illustrates the step of receiving at least one investment character, or financial character, or any risk and return, or risk and payoff preference. Examples of investment characters are stock symbol, a company name, or any other equivalent stock identifier or financial service identifier.

Step 73 in FIG. 7 illustrates the step of searching for a predefined amount of best performing strategies according to the received investment character or financial character. According to this embodiment, the system calculates a large amount of strategies for the at least one investment character and/or one financial character and searches for a predefined number of best performing investment strategies or financial strategies. A strategy may be regarded as best performing when it achieves the highest rating. The rating may be of a single parameter such as Strategy Return, or a weighted rating of more than one parameter, such as Strategy Return and Strategy Success Ratio.

Step 74 in FIG. 7 illustrates the step of returning the predefined amount of best performing stocks found for the investment character and/or financial character, accompanied with a current status. The user may utilize an end-user application for viewing the best performing strategy found.

Optionally, the investment character is selected from the group of: stock symbol, a company name, other equivalent stock identifier, financial service identifier, or a combination thereof.

Stock Value Chains:

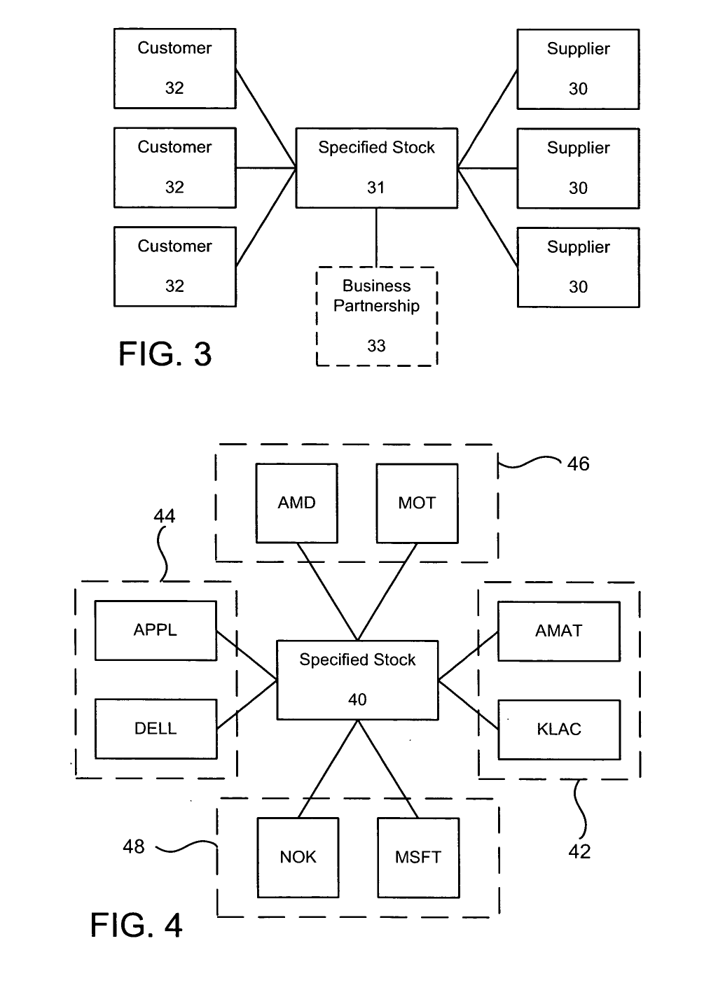

According to another aspect of the invention, stock and financial service indicators based on the stock's or financial service's value chain analysis are useful for indicating a stock or financial service offerings trend, or the trend of a group of stocks or financial services. The indication is based on the analysis of other stocks and financial services and/or financial conditions and/or prices of assets or liabilities in its value chain. FIG. 3 illustrates the value chain concept. The value chain may be updated according to available data and/or according to the available computer system performance. In one embodiment, the value chain is a chain of customers 32 and suppliers 30 of a company that is associated with a specified stock 31. For example, a value chain may feature at least two nodes, wherein the first node is a supplier of a service or a product and the second node is the customer of the first node or an asset or liability of the first node. The value chain may include a large amount of nodes, with each additional node may be a customer or consumer or debtor of the last node. Alternatively or additionally phrased, a value chain may be defined as a chain having at least two nodes, where the first is solely a supplier or asset or liability, the last is solely a customer or right owner or debtor, and all other nodes are suppliers or an asset or liability to their succeeding nodes and customers or right owner or debtor of their preceding nodes.

A value chain in accordance with one embodiment includes a selected entity, such as a public company, and entities that cooperate with the selected entity. A value chain in accordance with another embodiment includes a selected entity, such as a public company, and entities that compete with the selected entity.

FIG. 4 illustrates a value chain having four categories. The four categories are optional and are only for illustrative purposes. A value chain in accordance with the present invention may include one or more of the illustrated categories and optionally additional categories, which are not illustrated in FIG. 4. The first category, referenced by reference number 42, is suppliers of the specified stock 40. Optionally, the list of suppliers includes main suppliers and/or suppliers that the system holds information on. The second category, referenced by reference number 44, is customers of the specified stock 40. Optionally, the list of customers includes main customers and/or customers that the system holds information on. The third category, referenced by reference number 46, is competitors of the specified stock 40. Optionally, the list of competitors includes main competitors and/or competitors that the system holds information on. The fourth category, referenced by reference number 48, is entities that cooperate with the specified stock 40. Optionally, the list of cooperators includes main cooperators and/or cooperators that the system holds information on.

In one embodiment, the user is able to “navigate” the value chain as needed. For example, the user can expand or shrink the suppliers 42 area, the customers 44 area, the competitors 46 area and/or the cooperators 48 area.

The value chains in accordance with the present invention may be created as described by the following embodiments that should be regarded as non-limiting examples.

With reference to FIG. 8, in one embodiment, the value chain is created fully automatically. Step 82 illustrates the step of receiving information regarding predefined stocks or financial service offerings. The information may be obtained from a variety of sources such as company press releases, company website, newspapers, and other known in the art financial and industrial information sources.

Step 83 in FIG. 8 illustrates the step of analyzing the received information and identifying a connection that is relevant to a value-chain. The received information may be analyzed using known in the art techniques, such as, but not limited to, text analysis tools, or predefined keyword identification. Keyword examples are ‘joint venture’, ‘sell/sold’, ‘customer’, ‘project’, etc. Text analysis tools may be used to categorize a message and position it in a value chain. An example of categorizing is checking if a message is relevant to a customer, supplier or partner in a value chain of a selected stock or financial service provider. If relevant, the scope of relevancy is checked. In one embodiment, as a result of the analysis step, the name of the company/entity that is associated with the identified keyword and/or with the predefined stock is labeled as a customer, business partner, supplier, asset holder, or liability issuer. For example, a text analysis tool that reads a press release by Apple announcing that it would start using Intel's chips instead of Motorola's chips in the future versions of its products is very likely to spot company names (e.g. Intel, Apple, Motorola), and/or the product in focus (e.g. chips, CPU, chipsets), and/or action words (e.g. cooperation, working with) and/or descriptors (e.g. supplier, customer, partner). Based on the location of these words and their association, a text analysis tool in accordance with one embodiment is able to point which companies in the press release are a supplier and/or a customer and/or an owner and/or a debtor and/or a business partner.

Step 84 in FIG. 8 illustrates the optional step of assigning a value to the identified connection based on the meaning of the analyzed information, size of deal, or the number of connections between the two nodes.

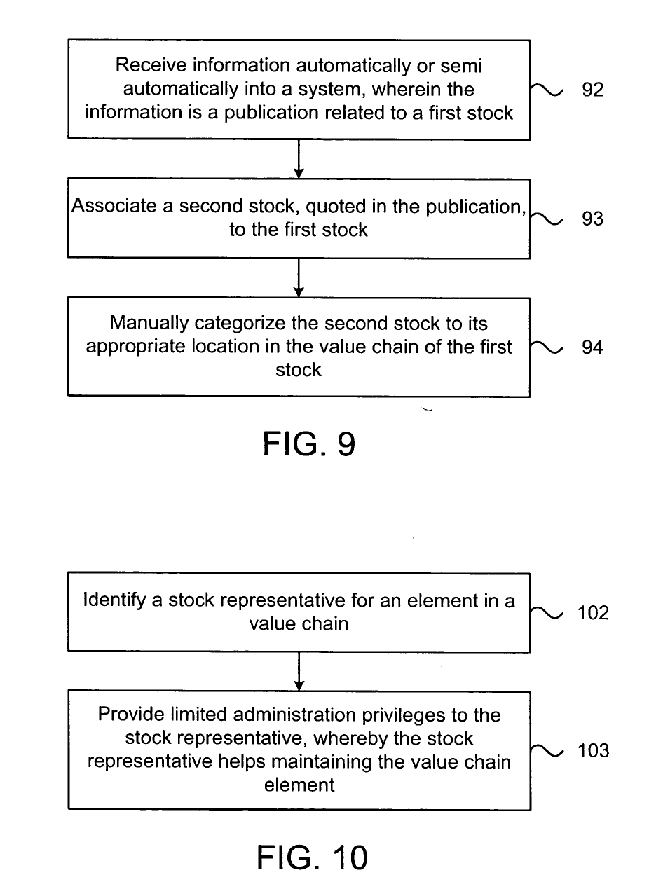

In one embodiment, the value chain is created semi automatically. A frequent problem in building a value chain is quality assurance of a fully automated creation of a value chain. According to this embodiment, a source of information is followed until the companies that are its customers, suppliers and partners are disclosed. Examples for sources of information, also referred to as publication related to a stock, are press releases, company advertisements, and company website. It is possible to find press releases and other company offerings by means of web-crawlers, a financial information supplier, or a supplier of company press releases or service offerings. With reference to FIG. 9, one embodiment comprises the following steps. Step 92 illustrates the step of receiving information automatically or semi automatically into a system, wherein the information is a publication related to a first stock. Step 93 illustrates the step of associating a second stock quoted in the publication to the first stock. The association may be based on the relationship between the stocks. Step 94 illustrates the step of manually categorizing the second stock to its appropriate location in the value chain of the first stock. Optionally, the step of manually categorizing the second stock may include the step of updating data relevant to the second stock in the value chain of the first stock.

For example, a text analysis tool that reads a press release by Apple announcing that it would start using Intel's chips instead of Motorola's chips in the future versions of its products is very likely to spot company names (e.g. Intel, Apple, Motorola), and/or the product in focus (e.g. chips, CPU, chipsets), and/or action words (e.g. co-operation, working with) and/or descriptors (e.g. supplier, customer, partner) but it is not certain that the text analysis tool will determine proper relations between the companies (e.g. which is the supplier and which is the customer). To do this in assured quality, in one embodiment, a manual process may be added in which the automated tool gives a human the company names suggestion for relationship between them, and the human accepts the proposed relation or denies it and corrects it manually.

With reference to FIG. 10, in one embodiment, the value chain is created and maintained by the companies and financial service providers that comprise it, optionally by using the following steps. Step 102 in FIG. 10 illustrates the step of identifying a stock representative for an element in the value chain. The information, which comprises the element in the value chain, may be obtained from a variety of sources such as company press releases, a company website, newspapers, and other available financial and industrial information sources. The stock representative may be any entity that is connected with the stock and/or represents some kind of authorization for the specific stock related information.

For example, a text analysis tool that reads a press article about Apple announcing that it would start using Intel's chips instead of Motorola's chips in the future versions of its products is very likely to spot company names (e.g. Intel, Apple, Motorola), and/or the product in focus (e.g. chips, CPU, chipsets), and/or action words (e.g. co-operation, working with) and/or descriptors (e.g. supplier, customer, partner) but it is not certain whether this is a fact or a speculation of the press. To do this in assured quality, in one embodiment, a stock representative (e.g. a senior manager in the company, Company spokesman) or any other authorized body (e.g. major shareholder, industry analyst, etc.) manually authorizes this stock related information and/or the value chain association between the stock and the stock related information.

Step 103 in FIG. 10 illustrates the step of providing limited administration privileges to the stock representative. The stock representative helps maintaining the element of the value chain that is relevant to the stock, and optionally its preceding and succeeding value chain nodes. The stock representative may assign a value to the connection based on the meaning of the connection, size of a deal, type or relation, or the significance of the connection.

In one embodiment, the value chain is created and maintained by the users of the system or by a community of users that use the system. This embodiment comprises the step of providing limited administration privileges to a community of users. The administration privilege enables the users to share knowledge and insights through the system, regarding each stock or company or financial service offering mentioned in the value chain and/or in the system. Moreover, a community user may assign a weight or other properties to a connection.

The privilege to insert new connections, edit connections, or perform any other action upon the connections or information may be restricted to registered users or to predefined users, and may feature different levels of privileges to different users based on their past contribution, quality of contribution, and other parameters. Optionally, the users' community is formed over the Internet.

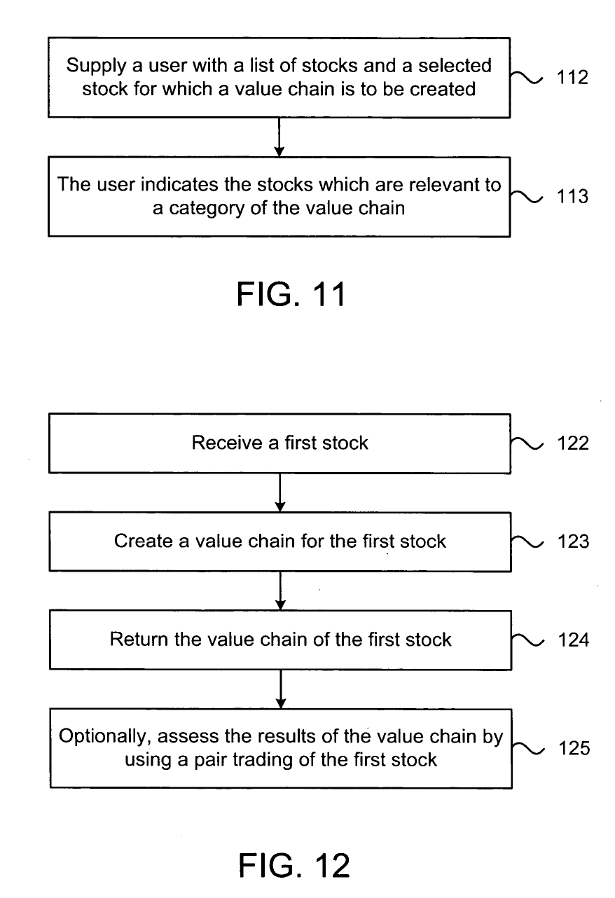

With reference to FIG. 11, another embodiment wherein the value chain is created and maintained by the users of the system or by a community comprises: the step 112 of supplying a user with a list of stocks and a selected stock for which a value chain is to be created; and the step 113 of the user indicating the stocks which are relevant to a category of the value chain.

The value chain categories may include, for example, suppliers, customers, competitors, and cooperators.

In one embodiment, a value chain and/or a value chain element are managed by a representative of a company that is relevant to the value chain, such as a company related to a stock that is part of the value chain. Optionally, the representative is supplied with the selected stocks and their value chain categories and is able to validate the connections. Value chain stocks that were validated, by a company representative and/or another entity or administrator, may feature a predefined marking, which indicates to the users of the system that the connection was authorized.

By using the methods exemplified below, the following value chain may be created. It is to be understood that the value chains in the following embodiments may comprise the shareholders of the company, the stakeholders of the company, and a combination thereof.

With reference to FIG. 12, one embodiment includes the following steps. Step 122 illustrates the step of receiving a first stock. Step 123 illustrates the step of creating a value chain for the first stock. Step 124 illustrates the step of returning the value chain of the first stock. And step 125 illustrates the optional step of assessing a stock based on the results of the value chain by using Econometrics. Econometrics, also known as pair trading or group trading, is a set of functions that show a stock Buy and Sell signals according to a buying or selling signals of associated stocks. The meaning is that a user selects the stock symbol and the system returns the stocks that are most relevant to the selected stock. Pair trading features the step of checking the correlations between stocks within the same industry/sector/value chain/stock market/currency/index/indices.

When a Buy or Sell recommendation is received for a specific stock, it is possible to receive an evaluation of the significance of the recommendation by checking the value chain or pair stocks. If the system returns a Buy recommendation and the Value chain or pair stocks also have Buy recommendations, the Buy recommendation is more significant, as opposed to a situation where the system returns a Buy recommendation and the Value chain or pair stocks have Sell recommendations, and vice versa.

If a stock is rising, it is worthwhile to buy its pair stocks, since there is a good chance that they are also rising. Therefore, this analysis may be used as an additional tool for making decisions or as an additional means of identifying stocks that have a potential of rising, or for identifying a future opportunity for investing in stocks that at present is not appropriate based on the technical analysis and/or based on other known means.

In one embodiment the at least one stock symbol is received from the investor sentiment barometer disclosed below. In that case, the value chain reflects an estimated chain effect based on the investor sentiment barometer. For example, the investor sentiment barometer may indicate that the investors' interest in stock ‘A’ is increasing dramatically, and therefore it is likely that stock ‘A’ price will increase. In that case, the value chain may indicate other stocks, which may be affected by the increase in stock ‘A’ price. Moreover, the value chain may include information received from the investor sentiment barometer. The received information may be integrated with any element of the value chain, including the selected stock and/or any of its value chain elements.

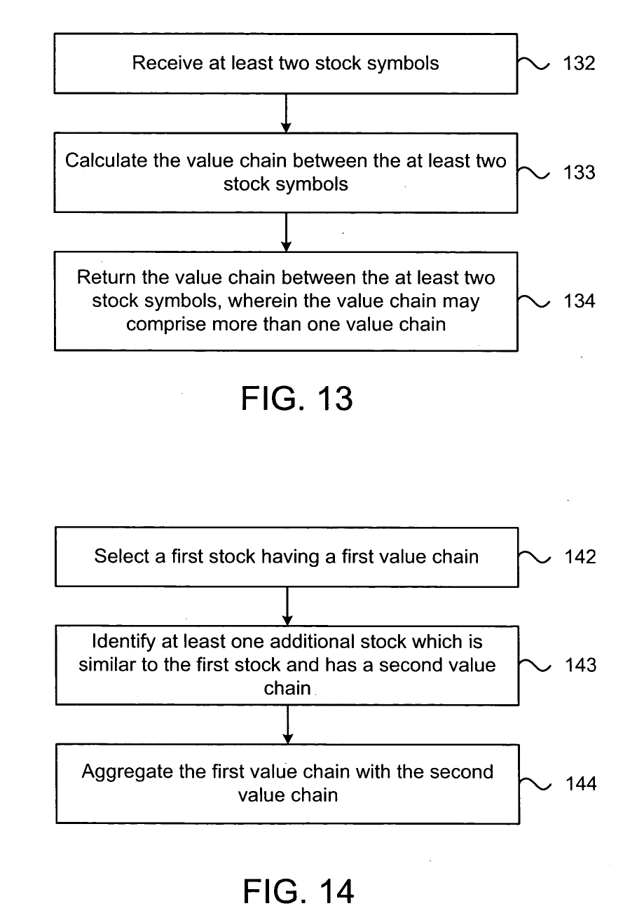

With reference to FIG. 13, in one embodiment of the invention, at least two stock symbols are received from a user and the value chain between the at least two stock symbols is calculated. Optionally, there may be more than one value chain between the two stock symbols. Step 132 in FIG. 13 illustrates the step of receiving at least two stock symbols. Step 133 in FIG. 13 illustrates the step of calculating the value chain between the at least two stock symbols. Step 134 in FIG. 13 illustrates the step of returning the value chain between the at least two stock symbols, wherein the value chain may comprise more than one value chain. It is to be noted that there are cases where there is no value chain between two selected stocks. In that case, no value chain may be returned, or an alternative value chain, may be between one or more alternative stocks, is to be returned.

In one embodiment of the invention, the system assigns a weighted evaluation to each investment strategy or financial service offer in order to allow a comparison of the various investment strategies or financial service offers for every stock or service type. For example, an evaluation may be reached by calculating for each investment strategy the Net Return (i.e., the accumulated yield of the transactions performed by the investment strategy, with deduction of transaction costs) and the Success Ratio (i.e., the percentage of positive yield trades out of the total trades performed by that strategy). A weighted evaluation of each strategy is then calculated according to a predefined formula.

For example, the weighted evaluation may balance between the Success Ratio and the return on investment and/or between the Risk and Payoff of an investment or of any other financial service. For example:
WE=(2*SR)ˆ6.5*R

Where:
WE—Weighted Evaluation score.
R—The net accumulated Return achieved by the investment strategy.
SR—Success Ratio, between 0% and 100% (calculated as the number of positive trades divided by total number of trades of a given investment strategy).

With reference to FIG. 14, in one embodiment, at least one value chain information is used for market analysis and/or other activities, which require the identification of stocks that are related to a selected stock. Step 142 in FIG. 14 illustrates the step of selecting a first stock having a first value chain. Step 143 in FIG. 14 illustrates the step of identifying at least one additional stock, which is similar to the first stock and has a second value chain. Step 144 in FIG. 14 illustrates the step of aggregating the first value chain with the second value chain. In one embodiment the value chains aggregation is performed on the basis of categories, such as aggregating the suppliers of a company represented by the first stock with the suppliers of a company represented by the second stock, and aggregating the clients of the company represented by the first stock with the clients of the company represented by the second stock.

Optionally, at least one of the value chains is created on demand. Optionally, the step of identifying the at least one additional stock comprises a comparison of at least one category of the first value chain with at least one category of available stocks. Comparing the value chain categories may identify stocks similar to the first stock. For example, if the first stock has a group X of suppliers and a group Y of clients and a second stock has the same group X of suppliers and group Y of clients, the first and the second stocks may be regarded as similar for the purpose of this embodiment. Optionally, the step of identifying the at least one additional stock comprises the steps of selecting at least one stock, determining the lag time between each of the additional stocks and the selected stock, and assigning a weight to each additional stock.

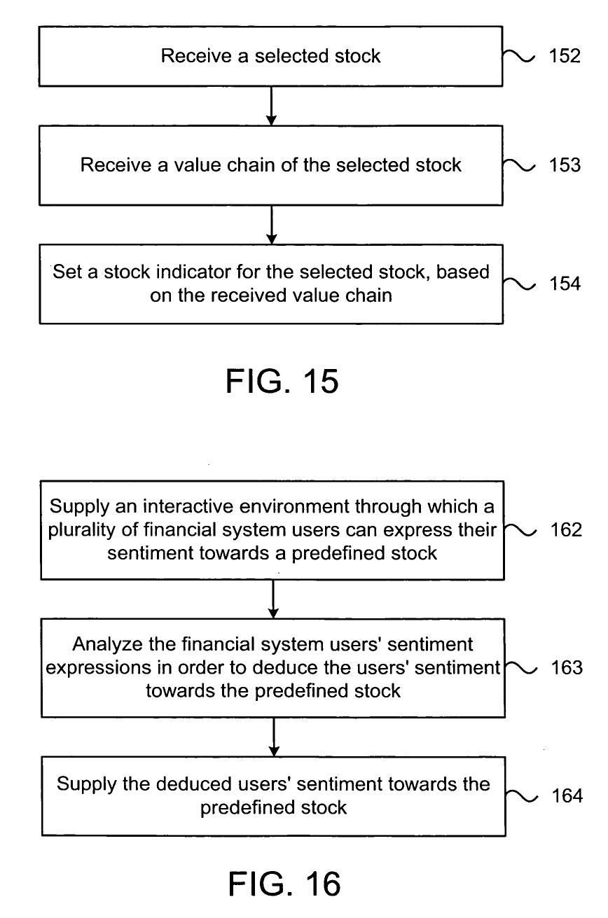

With reference to FIG. 15, in one embodiment, a user is supplied with a stock attractiveness indicator. The stock attractiveness indication is an indication of how worthwhile it is to buy or sell a stock, asset, debt, or financial service offering to which the indication pertains. The stock attractiveness indicator may be calculated using the following steps. Step 152 in FIG. 15 illustrates the step of receiving a selected stock. Step 153 in FIG. 15 illustrates the step of receiving a value chain of the selected stock. In one embodiment of the invention, a visual representation of the value chain of the selected stock is produced and optionally provided to a user. Moreover, the visual representation of the value chain may feature the suppliers, asset, or liability of the selected stock from one side, and the customers or right owner or debtor of the selected stock from the other side.

It is possible to build a value chain manually or mechanically, as disclosed in the value chain creation section.

Step 154 in FIG. 15 illustrates the step of setting a stock indicator for the selected stock, based on the received value chain.

Optionally, the step of setting the stock indicator for the selected stock is further based on a technical analysis of the selected stock.

Optionally, a company's degree of investment or consumption attractiveness while considering the effect of its value chain may be marked. Moreover, the stock attractiveness indicator value may be visually marked on the results supplied to the user of the system.

In one embodiment, the value chain graph may be navigated as follows. When the value chain is displayed, it displays the investment or consumption attractiveness indication of every company or stock or asset or debt or financial service offering in the value chain. I.e., it is possible to indicate how attractive each stock or financial service offering in a value chain is to buy or to sell or to consume. Clicking a stock or asset or debt or financial service offering which belongs to a value chain may open a list of the suppliers, customers, business partners, and competitors, i.e., a child value chain, of the selected stock or financial service offering. Optionally, the child value chain may also indicate the investment or consumption attractiveness of the nodes within it. In this embodiment, the system enables navigating within a value chain, opening other stocks and/or financial service offerings and having a macro-economical perception of the market.

Optionally, the user is supplied with a web of business connections on which the user is able to move and view signals, territories, assets, liabilities and companies that are or are not worthwhile investing in or consuming.

Moreover, a system having value chain capabilities may provide the following benefits:
Business development—a company may see who the business partners of a competitor are and submit them competitive business offers.
Rating companies—if a stock or a financial service offering is predicted to decline—or has already started to decline—it may be reasonable to predict that the stocks or the financial service offerings or assets or liabilities of its suppliers shall also decline.
Moreover, the embodiments are highly useful for credit assessment/rating, industry assessment, risk assessment, market assessment, investment banking, etc.
   Investor Sentiment Barometer:

According to another aspect of the invention, a behavior of a stock is estimated based on reactions, speculations and assumptions of investors and/or users of a financial system such as the financial systems disclosed above. The indication of investors' sentiment or users' sentiment towards the stock may be referred to as the Investor sentiment barometer. FIG. 2 is a schematic illustration of one optional investor sentiment barometer, which indicates whether the investors are positive or negative towards a specific stock. An optional way of finding users sentiment is analyzing a chat room of a specific stock. Optionally, the system may operate algorithms for analyzing text written by investors or users in chat room conversations and/or voice over IP conversations and/or forums and/or any other type of community communications. The result of the investors' opinion analysis may provide an indication of the investors' sentiment or the users' sentiment towards the stock. The provided indication may be referred to as the Investor sentiment barometer.

FIG. 16 illustrates one investor sentiment barometer embodiment. Step 162 illustrates the step of supplying an interactive environment through which a plurality of financial system users can express their sentiment towards a predefined stock. Step 163 illustrates the step of analyzing the users' sentiment expressions in order to deduce the users' sentiment towards the predefined stock. And step 164 illustrates the step of supplying the deduced users' sentiment towards the predefined stock.

The deduced users' sentiment towards the predefined stock may be supplied to a third party, to the financial system users, and/or supplied as an investor sentiment barometer.

In one embodiment, the interactive environment is a chat room. The chat room may be operated specifically for the predefined stock. Optionally, the step of analyzing the users' sentiment expressions is performed by operating text recognition algorithms.

In one embodiment, the interactive environment is a voice chat room and the step of analyzing the users' sentiment expressions is performed by operating voice recognition algorithms.

Optionally, the step of analyzing the users' sentiment expressions may include counting the number of users that are connected to elements in the interactive environment, which are relevant to the stock. As more users get connected to the interactive environment of a specific stock, there is a bigger chance that the stock is interesting and has good chances to rise.

Optionally, the step of analyzing the users' sentiment expressions may include the users' past sentiment expressions regarding the predefined stock. The users' sentiment expressions may change according to the stock. In one embodiment, the current sentiment expressions are normalized by the past sentiment expressions regarding the specific stock under analysis, and/or normalized by other relevant sentiment expressions.

In one embodiment, the interactive environment analyzing users' sentiment may include a stock portfolio component and the step of analyzing the users' holding the predefined stock in their portfolio. More users adding a predefined stock to their portfolio indicates rising interest and hence potential rise in the predefined stock's price and/or related companies' price. Users removing a predefined stock from their portfolio indicate declining interest and hence a potential drop in the predefined stock's price and/or related companies' price. Related companies may be, but are not limited to, companies on the same value chain

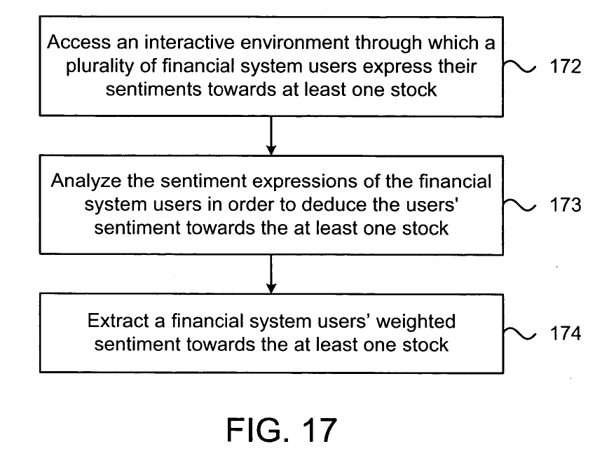

FIG. 17 illustrates another investor sentiment barometer embodiment. Step 172 illustrates the step of accessing an interactive environment through which pluralities of financial system users express their sentiments towards at least one stock. Step 173 illustrates the step of analyzing the sentiment expressions of the financial system users in order to deduce the users' sentiment towards the at least one stock. And step 174 illustrates the step of extracting a financial system users weighted sentiment towards the at least one stock.

In one example, the interactive environment may be a text based chat room and/or a voice chat room.

For example, implementations of an Investor sentiment barometer may include indicators to users such as: Is the investors' sentiment good or bad? Is a trend expected to change? Is there growing or declining interest in a certain stock or financial service offering? Is there growing or decreasing speculations in a certain stock or financial service offering?

The following are optional input sources for the algorithm that calculates the investors' sentiment.
News items or anything found in the news media.
Investor reactions to stock or financial service performance.
“collaborative filtering” such as “People who also liked this”, and “people who also bought that”.
The information produced by the disclosed financial system.
The number of users that are interested in the stock and/or financial service, and/or are watching the stock and or financial service, and/or are in a chat room of the stock or financial service offerings.
The number of users who read news relevant to the stocks and/or financial service offerings.
The number of users who read news relevant to a specific stock and/or financial service offering.
The number of users who searched for a specific stock or financial service offering in the site.
The number of users viewing pages that are relevant to a specific stock or financial service offering relative to the number of users viewing other stocks or financial service offerings pages.
The number of users that are checking a specific stock's or financial service offering's strategies. The more users there are that check a specific stock or financial service offering strategy, the higher the chance that there is an interest in the specific stock or financial service offering.
The number of updated news items regarding the stock and/or financial service offering.
The number of press releases regarding the stock and/or financial service offering.
Analysis of the total amount of trading. The more the stock is traded and/or the financial service offering is consumed, the more interest there is in the stock or in the financial service offering.
The number of Security Exchange Committee (SEC) filings that are received.
Delays in SEC reporting and types of SEC filings.
The amount of websites, blogs and forums that mention the stock or company and/or financial service offering.
The amount of time a user spends on examining, reviewing, checking, and/or considering a certain stock or financial service offering.
A poll of users voting in favor or against a certain stock or financial service offering.
The investor sentiment barometer trend in other stocks or financial service offerings in the same sector.

The higher the investors sentiment is, the greater the likelihood that the stock value is high. If the investors' sentiment is good and the stock does not rise, that could be a selling sign, because the stock may be at its peak. The worse the investors' sentiment is, the lower the expected stock value.

The investors' sentiment analysis results may be presented in a graphic manner. For example, showing a barometer with moving mercury, a number of thumbs up, indicators on a graph, and color changes on the graph.

It is to be understood that the information from the investor sentiment barometer may be used in many ways and for many purposes. The investor sentiment barometer is like seismographic data that enables predicting whether a stock or financial service offering may rise or decline. Based on the sentiment barometer analysis, it is possible to evaluate when it is worthwhile to buy a specific stock or a specific stock portfolio or a specific financial service offering or a combination of financial services offerings or a group of financial services offerings, and when it is worthwhile to sell.

It is appreciated that certain features of the embodiments, which are, for clarity, described in the context of separate embodiments, may also be provided in various combinations in a single embodiment. Conversely, various features of the embodiments, which are, for brevity, described in the context of a single embodiment, may also be provided separately or in any suitable sub-combination.

It is to be understood that the embodiments are not limited in their applications to the details of the order or sequence of steps of operation or implementation of the methods set in the description, drawings, or examples.

While the methods disclosed herein have been described and shown with reference to particular steps performed in a particular order, it will be understood that these steps may be combined, sub-divided, or reordered to form an equivalent method without departing from the teachings of the present invention. Accordingly, unless specifically indicated herein, the order and grouping of the steps is not a limitation of the present invention. Citation or identification of any reference in this application shall not be construed as an admission that such reference is available as prior art to the embodiments of the present invention.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and broad scope of the appended claims and their equivalents.

Any element in a claim that does not explicitly state “means for” performing a specific function, or “step for” performing a specific function, is not to be interpreted as a “means” or “step” clause as specified in 35 U.S.C. § 112, ¶ 6.

What is claimed is:

1. A computer-implemented method, comprising:
receiving a first stock;
creating a value chain for the first stock; and
returning the value chain of the first stock.

2. The method of claim 1, wherein the step of creating the value chain further comprises the steps of:
receiving information regarding predefined stocks or financial service offerings;
analyzing the received information;
identifying a connection between an information element and the first stock that is relevant to the value-chain; and
assigning a weight to the identified connection.

3. The method of claim 1, wherein the step of creating the value chain further comprises the steps of:
receiving information automatically or semi automatically, wherein the information is a publication related to the first stock;
associating a second stock, quoted in the publication, to the first stock; and
manually categorizing the second stock to its appropriate location in the value chain of the first stock, wherein the step of manually categorizing the second stock comprises updating data relevant to the second stock in the value chain of the first stock.

4. The method of claim 1, wherein the step of creating the value chain further comprises the steps of:
identifying a stock representative for an element in the value chain; and
providing limited administration privileges to the stock representative, whereby the stock representative helps maintaining the relevant value chain element.

5. The method of claim 1, wherein the step of creating the value chain further comprises the step of providing limited administration privileges to a community of users.

6. The method of claim 1, wherein the step of creating the value chain further comprises the steps of:
supplying a user with the first stock for which the value chain is to be created and with a list of stocks that may take part in the value chain; and
receiving from the user indications of the stocks which are relevant to the value chain.

7. The method of claim 6, wherein the user's indication comprises the relevant value chain category; and the user's indication is forwarded to a predefined administrator of the value chain for validation.

8. The method of claim 7, wherein information that was validated is marked accordingly.

9. The method of claim 1, wherein the value chain comprises at least one of the following entities: suppliers, customers, competitors and cooperating entities.

10. The method of claim 1, wherein a user is able to navigate the value chain.

11. The method of claim 1, further comprising the step of assessing the results of the value chain by using a pair trading of the first stock.

12. The method of claim 1, further comprising the step of receiving a pair trading result for at least one stock comprised in the value chain.

13. The method of claim 1, wherein the returned value chain comprises indications received from an investor sentiment barometer.

14. The method of claim 1, wherein the first stock is received from an investor sentiment barometer.

15. A computer-implemented method, comprising:
receiving a first stock symbol and a second stock symbol;
creating a value chain between the first and the second stock symbols; and
returning the value chain between the first and the second stock symbols.

16. The method of claim 15, wherein the returned value chain comprises indications received from an investor sentiment barometer.

17. The method of claim 15, wherein the first and the second stock symbols are received from an investor sentiment barometer.

18. The method of claim 15, wherein the value chain comprises at least one of the following entities: suppliers, customers, competitors and cooperating entities.

19. The method of claim 15, wherein the step of creating the value chain further comprises the steps of:
receiving information regarding predefined stocks;
analyzing the received information;
identifying a connection between an element of the information and the first stock symbol or the second stock symbol that is relevant to the value-chain; and
assigning a weight to the identified connection.

20. The method of claim 15, wherein the step of creating the value chain further comprises the steps of:
receiving information automatically or semi automatically, wherein the information is a publication related to the first stock symbol or to the second stock symbol;
associating a third stock, quoted in the publication, to the first stock or to the second stock; and
manually categorizing the associated stock to its appropriate location in the value chain, wherein the step of manually categorizing the associated stock comprises updating data relevant to the associated stock in the value chain.

21. The method of claim 15, wherein the step of creating the value chain further comprises the steps of:
identifying a stock representative for an element in the value chain; and
providing limited administration privileges to the stock representative, whereby the stock representative helps maintaining the relevant value chain element.

22. The method of claim 15, wherein the step of creating the value chain further comprises the step of providing limited administration privileges to a community of users.

23. The method of claim 15, wherein the step of creating the value chain further comprises the steps of:
supplying a user with the first and the second stocks for which the value chain is to be created and with a list of stocks that may take part in the value chain; and
receiving from the user indications of the stocks, which are relevant to the value chain.

24. The method of claim 23, wherein the user's indication comprises the relevant value chain category, and the user's indication is forwarded to a predefined administrator of the value chain for validation.

25. The method of claim 24, wherein information that was validated is marked accordingly.

26. The method of claim 15, wherein the value chain comprises more than one value chain.

27. A computer-implemented method, comprising:
receiving a selected stock;
creating a value chain for the selected stock;
setting a stock indicator to the selected stock, based on the value chain; and
supplying the value chain.

28. The method of claim 27, wherein the step of setting the stock indicator to the selected stock is further based on a technical analysis of the selected stock.

29. The method of claim 27, further comprising the step of setting a stock indicator to at least one of the value chain elements, based on a technical analysis of the at least one value chain element.

30. The method of claim 27, wherein the value chain comprises an investment attractiveness indication related to at least one of the stocks appearing in the value chain.

31. The method of claim 27, wherein the value chain is supplied to a user and the user can navigate the value chain.

32. The method of claim 27, wherein the step of creating the value chain further comprises the steps of:
receiving information regarding the selected stock;
analyzing the received information;
identifying a connection between the information and the selected stock that is relevant to the value-chain; and
assigning a weight to the identified connection.

33. The method of claim 27, wherein the step of creating the value chain further comprises the steps of:
receiving information automatically or semi automatically, wherein the information is a publication related to the selected stock;
associating a second stock, quoted in the publication, to the selected stock; and
manually categorizing the second stock to its appropriate location in the value chain of the selected stock, wherein the step of manually categorizing the second stock comprises updating data relevant to the second stock in the value chain of the selected stock.

34. The method of claim 27, wherein the step of creating the value chain further comprises the steps of:
identifying a stock representative for an element in the value chain; and
providing limited administration privileges to the stock representative, whereby the stock representative helps maintaining the relevant value chain element.

35. The method of claim 27, wherein the step of creating the value chain further comprises the step of providing limited administration privileges to a community of users.

36. The method of claim 27, wherein the step of creating the value chain further comprises the steps of:
supplying a user with the selected stock for which the value chain is to be created and with a list of stocks that may take part in the value chain; and
receiving from the user indications of the stocks, which are relevant to the value chain.

37. The method of claim 36, wherein the user's indication comprises the relevant value chain category; and the user's indication is forwarded to a predefined administrator of the value chain for validation.

38. The method of claim 37, wherein information that was validated is marked accordingly.

39. A computer-implemented method, comprising:
selecting a first stock having a first value chain;
identifying a second stock, which is similar to the first stock, and has a second value chain; and
aggregating the first value chain with the second value chain;

40. The method of claim 39, wherein at least one of the first value chain and the second value chain is created on demand.

41. The method of claim 39, wherein the step of identifying the second stock comprises a comparison of at least one category of the first value chain with at least one category of the value chains of available stocks.

42. The method of claim 39, wherein the step of identifying the second stock comprises the steps of: selecting a plurality of stocks, determining the lag time between each of the plurality of stocks and the first stock, and assigning a weight to each of the plurality of stocks.
